(19) United States
(12) Patent Application Publication
(10) Pub. No.: US 2016/0069988 A1
(43) Pub. Date: Mar. 10, 2016

(54) Platform-Independent Sonar Calibration Enabling System

(71) Applicant: Woods Hole Oceanographic Institution, Woods Hole, MA (US)

(72) Inventor: Kenneth G. Foote, Falmouth, MA (US)

(21) Appl. No.: 14/844,038

(22) Filed: Sep. 3, 2015

Related U.S. Application Data
(60) Provisional application No. 62/046,296, filed on Sep. 5, 2014.

(51) Int. Cl. G01S 7/52

(52) U.S. Cl. CPC G01S 7/52004

(57) ABSTRACT

The invention enables platform-independent sonar calibration. The associated systems and methods have application to underwater sonar systems and components, enabling an unprecedented flexibility in use. The systems and methods of the invention allow for efficient field calibration of sonars as configured for operational use, with high accuracy at low-cost. The invention provides in situ calibration capability for both stationary and moving sonar platforms and is suitable for calibration during operations.

### PRIORITY

This application claims the benefit of U.S. Provisional Application No. 62/046,296 filed Sep. 5, 2014, the disclosure of which is incorporated herein by reference in its entirety. The entire contents of the above referenced application and all citations are incorporated herein by reference and without disclaimer.

### FIELD OF THE INVENTION

The present invention relates to active acoustical devices, e.g., sonars and other acoustic transducer-based devices that are used actively to transmit a signal and receive echoes due to interaction of the transmitted signal with targets external to the device.

### BACKGROUND

Sonars transmit sound and receive resultant echoes for detection, classification, and/or quantification of ensonified objects, or more generally, of inhomogeneities, which are defined as spatial regions with differing acoustic properties relative to those of the immersion or propagation medium. Passive sonar involves listening for externally generated sounds, while active sonar employs emitted pulses of sounds, pings, to enable echo generation through the interaction of emitted sounds with external objects, including surfaces. In active sonar systems, sophisticated echo analyses are often performed first to ascertain the presence of ensonified objects, then to extract information regarding characteristic features and qualities. The span of applications for sonar echo analysis, beyond those of navigation and ranging, includes detection, identification, and quantification of fish in the water column, air bubbles in the surface layer or water column, plumes from hydrothermal vents and hydrocarbon seeps on the seafloor, suspended sediment in the water column, oceanographic features such as fronts, internal waves, stratification, temperature and salinity microstructure, and turbulence, freshwater plumes due to river discharge into the ocean, and wave height, among other things. Military applications include mine detection, seafloor measurement, surveillance, torpedo homing, and much more.

Sound generation by sonar is generally accomplished through the use of a projector, or transmitter, consisting of a signal generator, power amplifier, and electroacoustic transducer or transducer array. Sound reception by sonar is generally accomplished through the use of an electroacoustic transducer, which is often the same instrument that is used as the projector, pre-amplification, and analysis of the received echo. Directionality of both signal transmission and/or reception may be achieved in several ways, as through configuring several transducers in an array or through beamforming. These methods can concentrate the emitted acoustic energy into one or more beams and/or resolve the echo spatially by forming multiple beams. A region of interest can be sampled by moving a single beam or multiple beams mechanically, electronically (e.g., by scanning), or digitally. An acoustic beam or region of sensitivity may be narrow in cross section, similar to a searchlight beam, fan-shaped (narrow in one dimension and broad in the other), or very broad in cross section.

Sonars emit frequencies ranging from the infrasonic, less than 20 Hz, to the ultrasonic, greater than 15 kHz. The emission can be narrowband or broadband. Choice of a particular sonar is usually dictated by the application.

The sonar signal interacts with an object, i.e., an inhomogeneity, to produce an echo. For the simple estimation of the distance to an object, the time from transmission of a ping to reception of the echo can be used in conjunction with the known speed of sound within the medium to calculate the distance to the object. Echoes are sensitive to the geometry and physical properties of ensonified objects. In some cases, such as backscattering from air bubbles or the swim bladders of fish, size may be inferred from the echo spectrum. The Doppler frequency shift of echoes can be measured, enabling the speed of approach or retreat of objects relative to the sonar transducer to be determined. Localization of objects is achieved by measurement of phase or time difference in the echo received across the transducer array. Measuring the backscattering amplitude is critical to many applications requiring quantification, as in the determination of the numerical density of bubbles in a ship wake, or plume from a vent or seep, fish in a school, suspended particles of sediment in the water column, and seafloor properties, among other things.

The field use of sonar systems often occurs under harsh conditions, with risks of physical, electrical, and electronic damage. Examples include collisions of towed sidescan sonars with the seafloor; corrosion, other physical degradation (e.g., biofouling), and short-circuiting of all sonar transducers due to seawater exposure; ageing effects; and vibration including shock, with potential damage to electronic components. Because sonar backscattering analysis requires high-sensitivity detection and discrimination of complex echo patterns, the conditions of field use may potentially lead to degradation of performance fidelity and/or reliability of a sonar system. Degradation such as this could lead to erroneous conclusions regarding the comparability of measurements repeated over long intervals of time, or among different sonar systems, specification of the inherent measurement error, and/or expression of the output in absolute physical units of backscattering.

In order to confirm the performance fidelity of a sonar system, for example, in conjunction with field use or after system changes, a systematic assessment of system performance is required, i.e., calibration. Generally speaking, performance fidelity suitable to the intended use of a sonar should be confirmed periodically, preferably frequently, throughout the lifetime of the system. However, calibration of many sonar systems depends on the availability of specialized facilities, the use of which may incur the penalty of needing to change the transducer mounting configuration, as well as cabling and wiring, with an inevitable change in the performance being measured. Such reconfigurations mean the calibration results cannot be fully relied upon once the sonar is remounted in its normal configuration for operational use.

In the case of certain rather large sonar systems, once in service, any attempt at calibration would be so difficult, time-consuming, and costly that it is rarely done in actual practice.

Calibration methods for sonars using fixed suspension systems are well known. These methods generally involve suspending a standard target from the transducer platform, e.g., surface vessel on which the transducer is hull-mounted (FIG. 1), or from a stationary platform such as a tank or sea well (FIG. 2), necessitating a special transducer mounting, and a horizontally or obliquely-oriented beam. Suspension systems are most applicable for downward-looking sonars, but do not address the general needs of low-frequency sonars or sonars mounted on vehicles (e.g., towed sidescan sonars). Furthermore, there are no working calibration systems for use when either the sonar platform or calibration target is in motion.

Traditional calibration approaches such as the standard-target method are limited by the need for precisely located standard targets positioned at relatively short distances from the system being calibrated. These approaches do not address several other important calibration situations, namely (1) in-motion, or underway calibration of sonar systems, and (2) long-range calibrations, at ranges on the order of 0.1 to 0.3 km or more, required for calibration of sonars with operating frequencies in the audible or infrasonic range.

### Definitions

Analyzer means. As used herein the expression “analyzer means” or “analyzer” refers to signal analyzers in communication with both the locator-detector means and the sonar system as used in the inventive methods described herein. The data received from at least these two sources are used to provide and/or generate information necessary for the calibration of the sonar system.

Beamforming. The process of combining individual transducers in an array or transducer outputs from an array in order to achieve directionality.

Echo repeater. An echo repeater is a device designed to receive a signal, amplify this signal, and transmit the signal so amplified.

Locator-detection means. The locator-detection means (locator-detector, positional-detector) receives input from the referent-locator, and in some cases the sonar system, and provides data to the analyzer as to the position of the referent.

Platform. The platform is the vehicle or structure on which the sonar transducer and its electronics package is mounted. The platform may be stationary or mobile, mounted on a vehicle (e.g., a vessel, a ship, an underwater vehicle, an autonomous underwater vehicle (AUV), an unmanned remotely operated vehicle (ROV), a hybrid remotely operated vehicle (HROV), a human-occupied vehicle (HOV), a glider, a kayak, a submarine, a mini submarine, a tow body), or a structure (e.g., a mooring, a drifting buoy, an observatory, a float, a handheld unit, a tripod, etc.). “Platform-independent” in reference to the invention refers to calibration strategies that do not require referents to be affixed to, or mounted on, the sonar platform. Referents without physical connection or attachment to the sonar platform are sometimes referred to herein as “remote referents”.

Positional data refers to information (alternatively, data, signals, communications) which may be used either through computation or calculation or otherwise transformed to yield information enabling the precise localization of an object (e.g., a referent).

Referent. The sonar calibration methods of the invention employ a referent (e.g., target, standard target, non-standard target, standard source, calibrated hydrophone) to measure the performance of the sonar and/or sonar components. Preferred referents may comprise of (i) a standard passive target when the sonar is intended to measure or image backscattering, (ii) a standard acoustic receiver, such as a calibrated hydrophone, equivalent, or other suitable device for accepting a signal, when the sonar is to serve as a transmitter of sound, and (iii) a standard acoustic source when the sonar is to serve as a passive receiver of sound. In some less preferred embodiments of the invention, targets, acoustic sources, and acoustic receivers may not be well enough defined to be considered “standard”, but may still have utility in the inventive calibrations described herein. The seafloor (e.g., water bottom) is an example of a non-standard referent.

Referent-locator. Positional monitoring of the calibration referent is enabled by means of an associated locator means (e.g., referent-locator, target-locator, standard source-locator, or standard receiver-locator). Distinct from the sonar system being calibrated, the referent-locator provides precise positional information concerning the referent (e.g., target, standard source, standard receiver) to a locator detection means (e.g., locator-detector) operationally attached to or otherwise capable of communication with the analyzer component of the sonar system such that the locator-detector can provide information regarding the position of the referent relative to the sonar system, particularly during the calibration process.

Referent position. Referent position and/or referent location refers to the precise location of the referent at the time of signal propagation from or ensonification of the referent. Positional information is provided by the referent-locator in sufficient detail for determination of referent position relative to the transducer in terms of range from the transducer center and angle relative to the transducer axis. Referent position is established by the referent-locators in conjunction with the locator-detectors of the invention.

Signal exchange as used herein refers to communication, data transmission, or signal flow in one or both directions relative to a device, system, or component of the invention.

Sonar calibration. Sonar calibration refers to the measurement of one or more aspects of the performance of a sonar system or its parts. Calibrations are performed for a variety of purposes including but not limited to the quantification of component or system performance, establishment of performance reproducibility, detection of performance problems, determination of long-term system stability, and the determination of system performance relative to specifications.

With respect to measurement or imaging of backscattering, the calibration objective is determination of the combined transmit-receive response of the sonar system. With respect to use of the sonar mainly to transmit sound, the objective is determination of the transmitting response function of the sonar used actively. With respect to use of the sonar mainly to receive sound, the objective is determination of the receiving sensitivity function of the sonar used passively. In all cases, the directionality of the sonar transducer is a consideration, if not an object of determination of the calibration.

It is also generally an objective of sonar system and/or component calibration to enable the output of the system and/or component to be expressed in consistent units, either relative or absolute; to ensure performance fidelity (i.e., consistency in performance over time); to detect possible performance problems; to enable comparison of measurements made by the same system at different times or by other sonar systems, or with modeling results and/or simulations; to gauge performance relative to specifications; among other things.

Relative sonar calibration refers to measurement of the performance of a sonar so that the output can be expressed in consistent units, especially with respect to frequency. Absolute sonar calibration refers to measurement of the performance of a sonar so that the output can be expressed in absolute physical units. In the case of a sonar being calibrated for use in measurement or imaging of backscattering, the output would be expressed in absolute units of backscattering, such as square meters of effective backscattering area relative to the effective area being ensonified in one or more pings.

Sonar calibration assembly. This term refers to a sonar system to be calibrated in conjunction with the items necessary to perform the inventive calibrations. Specifically, the assembly is comprised of the sonar system to be calibrated and the calibration components. The calibration components include at a minimum: a calibration referent, a referent-locator, and a referent-locator-detector (i.e., locator-detector). The calibration components may or may not also include tools necessary to perform physical adjustments or repairs to the sonar and/or its components in relation to the calibration process. In some embodiments, the calibration assembly may include more than one of any or all of the specific calibration components.

Sonar system. “Sonar” and “sonar system” are used synonymously herein. A sonar system comprises, minimally, a transducer or transducer array and a set of electronics to control transmission of a signal and reception of an echo due to ensonification of an object having different physical properties (e.g., mass density, sound speed, porosity, fluid density, pore size, permeability) relative to those of the ambient, or propagation, medium. The functionalities of an acoustic transmitter, or projector of sound, and an acoustic receiver, or hydrophone, are both present, whether the sonar is used to transmit and/or receive sound.

Sonar systems are generally characterized by the geometrical configuration of their transmitting and receiving transducers. In a traditional sonar system, these transducers are co-located. In such a ‘monostatic” configuration, the two transducers may be exactly co-located, as in the case of a single transducer used both to transmit and receive sound, or in such close physical proximity relative to the range of application that they function as being essentially co-located. Sometimes the transmitting and receiving transducers are well separated in a “bistatic” configuration. When two or more well-separated receiving transducers are used in conjunction with a transmitting transducer, the configuration is termed “multistatic.”

Standard acoustic receiver. A standard acoustic receiver (e.g., standard receiver) is a calibrated hydrophone or other equivalent sound or sound pressure receiver whose performance is known by comparison against or measurement with another hydrophone that itself has been calibrated or by measurement with a laser interferometric system, with ultimate traceability to a primary standard. For exemplary hydrophone calibration methodologies, see Robinson et al., 2006 (J. Acoust. Soc. Am. 120, 1366-1373). The “acoustic receivers” and standard acoustic receivers described herein are distinct from the acoustic receiving functions of the sonar systems to be calibrated by the inventive methods and devices.

Standard acoustic source. A standard acoustic source is a sound source whose performance is known by comparison against or measurement with another calibrated device, e.g., a standard source, or a calibrated hydrophone. The “acoustic sources” and “standard acoustic sources” described herein are distinct from the acoustic transmitting functions of the sonar systems to be calibrated by the inventive methods and devices.

Target. A target is a special case of referent. The term “target” in relation to the calibration systems and methods described herein refers to an object used for the determination of the overall functionality of the sonar. The primary requirement of the sonar target is that it produces an echo following impingement, also referred to as ensonification, by a sonar ping and that the echo is detectable by the sonar system. It is intended that the sonar signal will impinge on the target and produce an echo which can then be analyzed to determine the performance of the sonar system. Typically large numbers of echoes due to repeated pinging will be analyzed during a calibration. The term target includes both standard targets and non-standard targets (e.g., seafloor).

A standard target is a special case of referent for sonar calibration when the operational use of the sonar is measurement or imaging of backscattering. Typically a standard target is a compact, finite object whose acoustic scattering properties are known either a priori, as by calculation on the basis of knowledge of the geometry, dimensions, and/or material composition of the object, or a posteriori, on the basis of measurement of the object. Those targets whose acoustic scattering properties are known a priori constitute primary standards, while those whose acoustic scattering properties are known a posteriori constitute secondary standards, as their measurement depends on other devices, themselves requiring calibration.

Other, non-standard targets may also serve as referents when the operational use of the sonar is measurement or imaging of backscattering. Under certain conditions, the sea surface or seafloor may serve as a non-standard target.

Target strength refers to the effective backscattering area of the target. Specifically, target strength is equal to ten times the common logarithm of the backscattering cross section normalized to the square of a reference distance, usually equated to 1 m. Backscattering cross section is proportional to the square of the form function or square of amplitude of backscattering intrinsic to the target (Neubauer et al. (1974) J. Acoust. Soc. Am. 55, 1123-1129; Foote (1982) J. Acoust. Soc. Am. 71, 742-747). When measured, this quantity is customarily extracted from the echo with compensation to remove range-dependent effects due to propagation of the transmitted signal from the sonar transmitting transducer to the target and propagation of the backscattered signal from the target to the sonar receiving transducer.

Transducer. A device, typically but not always electromechanical, electromagnetic (e.g., light, radiation), or acoustic that converts or transforms an electrical signal into a pressure wave (or other form of energy), and vice versa.

Transducer array. Several transducer elements that are used together, for example, to increase the transmitted power, receiver sensitivity, or by beamforming, the concentration, noise level, or directionality, of transmitted or received sound. A transducer array is often referred to in the singular as a “transducer”.

### FIGURE CAPTIONS

FIG. 1. Platform-dependent sonar calibration onboard a vessel. This figure depicts a three-point platform-dependent sonar calibration known to the art. A standard target (insert A) is suspended by lines (B) from the rails (insert C) of a vessel afloat. The specifications of the standard target, as well as its acoustic properties, including target strength, are known, as is the position of the standard target relative to the hull-mounded sonar system. Figure reprinted with permission. Foote (1983), (J. Acoust. Soc. Am. 73, 1054-1063 p. 1059).

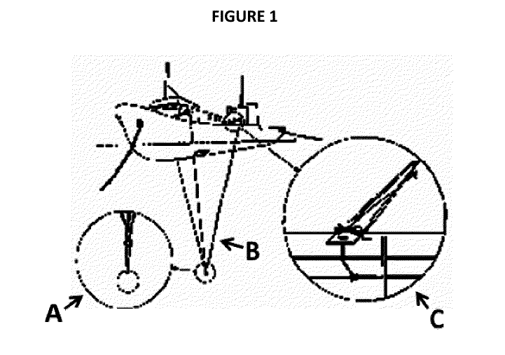

FIG. 2. Platform-dependent sonar calibration at a land-based facility. This figure depicts a single-point platform-dependent sonar calibration of the art. A standard target (B) is suspended in the sea well facility (C), with depth known to ±0.5 mm. The transducer (A) of the sonar being calibrated is mounted on a special adaptor plate attached to a stiff vertical shaft, which can be rotated about the long axis with a nominal precision ±0.01 deg. The position of the standard target relative to the transducer, including its orientation, is known. Figure reprinted with permission. Foote et al. (2005) (J. Acoust. Soc. Am. 117, 2013-2027).

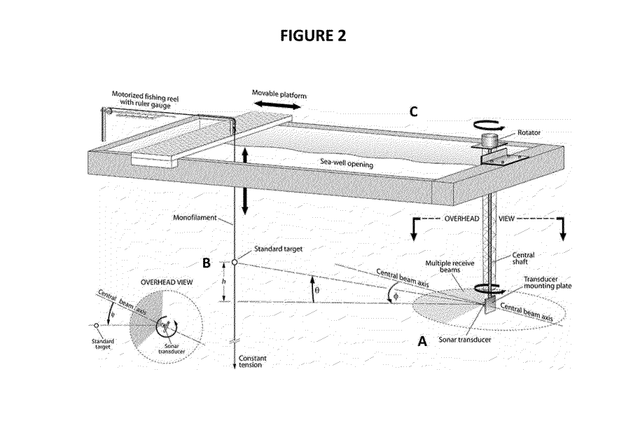

FIG. 3. Calibration assembly schematic. Arrows indicate data/information flow between specific assembly components. Dashed arrow lines indicate optional data flow pathways. The identity of the numbered components are as follows: transducer (e.g., sonar system) 1, referent 2, echo/ping (acoustic signal) 3, optional acoustic signal 4, optional physical link between referent and locator 5, optional signal path between referent and referent-locator 5a, referent-locator 6, locator-detector system 7, positioning information output 8, optional signal path 9, analyzer 10, referent position information signal path 11, optional signal path 12, optional signal path 13, sonar data output 14, optional signal/data path 15, optional signal/data path 16, calibration output 17.

### SUMMARY OF THE INVENTION

The invention described herein provides low-cost and reliable systems and methods for the calibration of sonar systems. In particular, the inventive systems and methods provide the capacity for calibration, recalibration, and performance verification in the environment of use (e.g., in situ) without the complications and costs of using a sonar calibration facility or traditional sonar-mounting apparatus. In accordance with the described systems and methods, any sonar system employed on a vehicle or structure may be suitable for calibration at a plurality of depths and may be calibrated while stationary, in motion, or during a mission or operation.

In one aspect, a sonar calibration assembly may comprise a sonar system with at least one sonar transducer, a remote referent detectable by the sonar system, a referent-locator having a known position with respect to the referent, a locator-detector capable of determining the location of the referent-locator, and an analyzer. The referent-locator is capable of providing referent positional information to the locator-detector. The locator-detector is capable of providing a signal to the analyzer regarding said referent position, enabling the analyzer to generate a signal useful for calibrating the sonar system. The referent-locator is most often activated to send positional information to the locator-detector in response to a received ping from said sonar system.

The referent-locator communicates positional information to the locator-detector by means of a signal including an electromagnetic signal, a radar signal, a microwave signal, an optical signal, an acoustic signal, a pressure wave, a reflected signal, and a scattered signal. In some embodiments, the referent is a target or a standard target. The referent may be physically linked to the referent locator. In another embodiment, the referent is physically separated from the referent. In some embodiments, the referent-locator is located on a buoy, a float, a vehicle, an AUV, or a landmark. In some embodiments, the referent-locator acquires the information for localizing the referent by global positioning satellite (GPS) communication, radio communication, by mapping, the associated vehicle navigation system, or by a known location.

The sonar system may be selected from the group comprising an echo sounder, a scientific echo sounder, a single-beam sonar, a dual-beam sonar, a split-beam sonar, a multibeam sonar, a scanning sonar, a sidescan sonar, a phase-measuring sidescan sonar, a monostatic-array sonar, a bistatic-array sonar, a multistatic-array sonar, a two-dimensional billboard-type array sonar, a three-dimensional sonar, a parametric sonar, a sub-bottom profiling sonar, and modifications and derivatives thereof.

In some embodiments, the locator-detector is integral to the sonar system. In other embodiments, the locator-detector is modular and connected to the sonar system, in some cases through a digital interface.

In another aspect, the sonar calibration assembly calibrates the sonar in situ. The sonar calibration assembly may perform sonar calibration while stationary, in motion, or during operations. The sonar calibration assembly measures at least one aspect of sonar performance selected from the group comprising transmit response, combined transmit-receive response, receiver sensitivity, onset of cavitation, source level, dynamic range, maximum detection range, receiver saturation limit, lower limit of receive sensitivity, nearfield-farfield transition, linearity in response, directionality (e.g., beam pattern), and self-noise of the system.

In another aspect, the invention includes a platform-independent sonar calibration package for use in calibrating a sonar system comprising a standard target in communication with a target-locator and a locator-detector. The target-locator is capable of providing target positional information to the locator-detector, and the detector is capable of providing an output signal regarding target position in a form suitable for use in a sonar calibration algorithm. The sonar calibration is performed in situ. In one embodiment, the target and target-locator are physically linked.

In other embodiments, a method is provided for determining the state of calibration of a sonar system comprising the steps of: (i) providing and deploying a referent and a referent-locator system; (ii) initiating the sonar system and referent-locator system to commence signal transmission, with a common reference time; (iii) executing a series of measurements based on signal exchange between the referent and sonar; and (iv) determining the sonar transfer function or characteristic from a primary acoustic measurement to determine an aspect of sonar performance. In one embodiment, the sonar calibration is performed in situ. In some embodiments, the target and the target-locator are physically linked. In some embodiments, the method further includes the step of the referent-locator acquiring the information for localizing the referent by global positioning satellite (GPS) communication, radio communication, by mapping, the associated vehicle navigation system, or by knowing the location. The referent-locator communicates signal transmission to the sonar system by means of the locator-detector by a signal selected from the group comprising an electromagnetic signal, a radar signal, a microwave signal, an optical signal, an acoustic signal, a pressure wave, a reflected signal, and a scattered signal. In the determining of the sonar transfer function or characteristic, at least one aspect of sonar performance is determined for determining the state of calibration selected from the group comprising transmit response, combined transmit-receive response, receiver sensitivity, onset of cavitation, source level, dynamic range, maximum detection range, receiver saturation limit, lower limit of receive sensitivity, nearfield-farfield transition, linearity in response, directionality (e.g., beam pattern), and self-noise of the system. In another embodiment, the method further comprises the step of employing the determined sonar transfer function or characteristic for calibration of the sonar system.

### DETAILED DESCRIPTION OF THE PREFERRED EMBODIMENTS

Overview. The invention provides platform-independent calibration systems and methods for underwater sonar systems with a heretofore unachievable flexibility of use. The systems and methods of the invention allow for low-cost calibration, recalibration, and confirmation of sonar system performance attributes over the active lifetime of the device. A particularly useful aspect of the invention is for the calibration of sonar instrumentation following upgrade or repair processes. In another aspect, the invention provides in situ calibration capability for both stationary and moving sonar platforms at a plurality of depths.

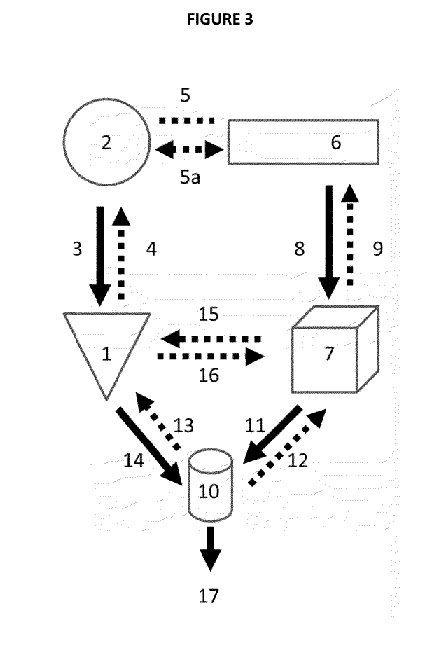

The inventive calibration assemblies, devices, and components described herein are schematically represented in FIG. 3. The invention provides means to determine (e.g., localize) and/or monitor referent 2 positioning relative to a sonar system 1 being calibrated, thereby allowing the referent 2 to be of either fixed or moving position anywhere within the sonar range (e.g., up to 0.05 km, up to 0.1 km, 0.1 to 0.3 km, up to 0.5 km, or more). Positional monitoring of the referent 2 is generally enabled by a referent-locator means 6, which provides positional information 8 about the referent 2 to a locator-detection means 7 capable of communication via 11 or optionally 12, with the analyzer 10 component of the sonar system or optionally with the referent-locator 6 via 9. The analyzer 10 integrates referent 2 positional information provided by the detector 7 into the calibration algorithm. Calibration may be accomplished with or without additional apparatus.

In one embodiment of the invention, a sonar system 1 is fabricated with an incorporated (e.g., integral) locator-detection means 7. A referent 2 with an associated locator means 6 is also provided, wherein the locator-detection means 7 is functionally matched to receive a signal from the referent-locator 6. In another embodiment, the sonar system 1 has a data transfer capability 15, 16 to accommodate attachment of and/or communication with a modular locator-detector 7. In a further embodiment, the sonar system 1 comprises a networkable digital interface capable of communicating with the locator-detection means 7 and/or a separate analyzer or computer 10, wherein the analyzer 10 is capable of producing output 17 necessary for the calibration process. In still another embodiment, the locator means 6 and the functionally matched locator-detection means 7 are provided as a kit for use with a sonar system 1 and a referent 2.

The sonar system to be calibrated. Any calibratable sonar system comprising transmitter and receiver functions is suitable for use with the invention described herein. Such preferred systems include those selected from the group of: echo sounders, scientific echo sounders, single-beam sonars, dual-beam sonars, split-beam sonars, multibeam sonars, scanning sonars, sidescan sonars, phase-measuring sidescan sonars, monostatic-array sonars, bistatic-array sonars, multistatic-array sonars, two-dimensional billboard-type array sonars, three-dimensional sonars, parametric sonars, sub-bottom profiling sonars, and modifications and derivatives thereof.

Sonar systems suitable for calibration also include those devices employed in applications such as seafloor mapping, route surveys, obstacle avoidance, active sonar imaging, uncharted navigation, continental shelf charting, marine research (e.g., monitoring hydrothermal vents, areas of seismic interest), disaster management, surveillance, port/harbor surveys, unstable terrain investigation, pipe/cable monitoring, sediment data collection, among other uses.

Suitable mobile sonar platforms include surface vessels, ships, surface drifters, towed vehicles, sub-surface vehicles such as remotely operated vehicles (ROVs), autonomous underwater vehicles (AUVs), hybrid remotely operated vehicles (hROVs), human-occupied vehicles (HOVs), submarines, mini-submarines, gliders, kayaks (e.g., JetYak), and other submersibles. Sonars present on stationary platforms such as moored buoys and structures (e.g., moorings, drifting buoys, observatories, floats, tripods, handhelds, communication nodes, etc.) positioned on or near the sea floor or elsewhere within the water column (e.g., pond, lake, water source, fresh water, brackish water, salt water, estuary, fjord, any suitable water body) are also considered within the invention.

The platform-independent referents 2 of the invention are physically independent of the sonar to be calibrated, requiring no affixation or mounting to the sonar platform. Referents 2 without physical connection or attachment to the sonar platform are referred to herein as “remote referents”. Furthermore, incorporation of the inventive referent-locators 6 into a calibration procedure allows the referent 2 and referent-locator 6 to be located at a range from the sonar system (e.g., up to 50 m, up to 100 m, 100 m to 1 km, up to 10 km, up to 20 km or more) including depths up to 50 m, up to 100 m, up to 1,000 m, up to 6,000 m, up to 11,000 m, or full-ocean depth. Alternatively in embodiments employing referents such as echo repeaters, hydrophones, or standard sources, ranges of 20 km to 100 km or greater may be achieved. Useful operating distances vary with the sonar operating frequency. At the extreme ends of the envisioned applicable frequency spectrum, the stated range limits can be exceeded. For example, at frequencies of order 1 MHz and higher, measurement ranges may typically be less than several meters. At frequencies less than 1 kHz, measurement ranges could exceed 10 km. At intermediate frequencies, (e.g., 12 kHz to 40 kHz), typical measurement ranges are on the order 10 m to 500 m. Other potential frequency bands or ranges include 12 kHz to 40 kHz, up to 110 kHz, up to 200 kHz, 40 kHz to 110 kHz, 110 kHz to 200 kHz, 200 kHz to 240 kHz, and greater than 240 kHz. Calibration measurements can also be made in the sonar transducer nearfield, allowing shorter-range measurements than is the case with ordinary farfield measurements.

Calibration of sonars must take into account the geometrical properties of their transducers: the target must be ensonified in one or more beams, possibly requiring beam-steering or control of the transducer orientation and/or movement of the target. Specific guidance for these and other details are taught by Foote et al. 2005 (J. Acoust. Soc. Am. 117, 2013-2027).

The calibration system and calibration components. The inventive sonar calibration systems and components operate independently of the sonar platform being used. Specifically, the calibration components may be used with any sonar system without the need for physical integration into the system. Embodiments wherein a locator-detector 7 is incorporated into the sonar hardware or its control system are also contemplated and considered part of the invention. In most cases however, the referent 2 and its associated positioning system (e.g., referent-locator 6) will be distinct from the sonar system component(s).

The referent and its use. Referents 2 of the invention consist of essentially three types: targets (e.g., standard targets, non-standard targets), acoustic sources, and hydrophones or functional equivalents thereof. Referent type is selected according to the needs of the calibration being performed. In all cases, the referent 2 is associated with a referent-locator 6, according to the means described herein. Each form of referent 2 and its selection is described below.

As previously mentioned, the referent 2 requires no fixation to the sonar device (i.e., platform-independent), providing a level of flexibility in the possible location of the referent 2. In some embodiments, the referent 2 is attached by a secure means such as a line or chain to the seafloor as a permanent mounting which is often useful in regions where the sonar system 1 is often employed in operations to provide routine sonar calibration. In other embodiments, the referent 2 is stationary in a removable manner such as by an anchor or weight on the seafloor, by placement on a landmark, attachment to a buoy, or other connection to allow the referent 2 to remain in a removably fixed (e.g., stationary) position for maintenance or use elsewhere. Any suitable fixed mounting method in the water column or water bottom may be used as known by one skilled in the art.

In some embodiments, the referent 2 is mobile. In such cases, the referent 2 and/or the referent-locator 6 may be mounted, integrated, or combined with a vehicle, a float, a drifter, a buoy, or the like. When the referent 2 is combined with a vehicle such as an AUV or ROV, the vehicle may remain within range of the sonar system 1 or scheduled to pass within range of the sonar system 1 for providing the means for sonar calibration. The referent positional information may be known through the position of the vehicle with respect to the sonar system 1 or through the vehicle's onboard navigation. In other embodiments, the referent 2 and/or referent-locator 6 are located on a buoy, in particular a weather buoy (e.g., an Argo float) or a drifter. As these buoys often provide real-time positional information, among other data, the location of the referent 2 may be provided to the sonar system 1 by means of the referent-locator 6 or through direct communication with buoy.

Target referents. A target is a special case of referent 2. The primary requirement of the sonar target is that it produces an echo following impingement by a sonar ping and that the echo is detectable by the sonar system 1. Suitable standard-target referents used by the invention are known to the art and described in, for example, the ANSI/ASA S1.20-2012, “American National Standard: Procedures for calibration of underwater electroacoustic transducers” (Acoustical Society of America, Melville, N.Y., 2012). As with all referents 2 of the invention, a target, standard or non-standard, may be fixed or mobile (e.g., adrift because of attachment to a surface float or drifter (e.g., Argo float, weather buoy), in motion, hovering). To be useful, the target must be deployed within the detection range of the sonar to be calibrated. In addition, because of the general directionality of sonar transducers, it is essential for a successful calibration that the position of the standard target be known relative to the sonar transducer 1 and its orientation. The instant invention provides localization means in the form of referent-locators 6 to establish the precise location of the referent 2 during the calibration process, therefore the properties of the standard target must also be amenable to detection by the referent-locator 6. Furthermore, the method of association or connection of the referent-locator 6 to the standard target must not detrimentally impact the echoes to be produced by the standard target during calibration. One suitable attachment strategy involves the suspension of a target or standard target by physical tether (e.g., monofilament nylon line, Spectra fiber, cable, wire), the acoustic properties of which are relatively similar to those of the ambient immersion medium. In some embodiments, a chain is employed to attach the target as long as the echo produced by the chain upon impingement of the target may be dominated (drowned out) by the echo of the target.

In embodiments where the referent 2 is a target, a standard target with high target strength is often preferred. Suitable standard targets are relatively light weight (e.g., less than 250 newtons (N), preferably less than 200 N, and in some instances, less than 150 N, 100 N, or 50 N) and of small geometrical cross sectional area (e.g., maximum linear dimension of 5 mm to 1,000 mm or less, often 5 mm to 500 mm or less, or in some cases less than 300 mm) relative to the sonar beamwidth at the range of intended use. Standard targets known to the art may be used with the inventive referent-locators 6 for calibration of sonars with operating-frequencies spanning the total range 1 kHz-3.2 MHz. Typical standard targets in order of increasing size include: a) 10 mm diameter sphere of tungsten carbide with 6% cobalt binder for use at megahertz frequencies exemplified by Foote et al., 2005 (Proceedings of the International Conference ‘Underwater Acoustic Measurements: Technologies and Results,’ Heraklion, Crete, Greece, 28 Jun.-1 Jul. 2005, pp. 501-508), b) 38-mm diameter sphere of the same material for use in calibrating narrowband scientific echo sounders at 38 kHz, 120 kHz, and 200 kHz (Foote and MacLennan (1984) J. Acoust. Soc. Am. 75, 612-616; Foote (2006) in Oceans 2006 MTS/IEEE Boston Conference Proceedings, 4 pp. [doi: 10.1109/OCEANS.2006.306944]; Foote (2007) in Oceans 2007 Europe IEEE Aberdeen Conference Proceedings, 4 pp. [doi: 10.1109/OCEANSE.2007.4302355], c) 60-mm and 64-mm diameter spheres of electrolytic-grade copper for use in calibrating narrowband scientific echo sounders at 38 kHz and 18 kHz, exemplified by Foote (1982) (J. Acoust. Soc. Am. 71, 742-747; Foote (2001) in Oceans 2001 MTS/IEEE Conference Proceedings, Vol. 4, pp. 2503-2505 [doi: 10.1109/OCEANS.2001.968394], and d) 280-mm diameter sphere of aluminum alloy for use in calibrating mid-frequency sonars over the band 1 kHz to 6 kHz (Foote et al., (2007) J. Acoust. Soc. Am. 121, 1482-1490).

Target shape. In most embodiments, it is desirable that the target strength not depend on the target orientation. One approach to achieving directional independence is through the use of a spherically symmetrical target. Spherically symmetric or round targets are typically attached to a suspension line by a hand-made, minimum-knot container, or bag, made of the same monofilament nylon line, or other suitable line, as that of the suspension (Foote et al., 1987, ICES Coop. Res. Rep. 144, 69 pp.). When conditions for target detection are not optimal, other suitable target geometries may be used (e.g., a tri-corner, retro-reflector, corner cube reflector, focusing sphere, a cube, a planar surface, a mirrored surface shape). In general, any suitable shape capable of impingement by the transducer beam may be employed for the target. In some cases, it may be desirable for the target strength of the standard target to be representative of targets of operational interest (e.g., mines, fish, bubbles, plumes).

Target material. The target and associated target-locator will most often be deployed over-the-side from vessels at sea or in a freshwater body, hence subject to handling by hand, by winch, or by hoist. The target/target-locator assembly should, therefore, be reasonably robust. For longer-term deployments, it should also be resistant to corrosion. In a fast installation, bio-fouling can be avoided or minimized through choice of the material and/or by a bio-fouling prevention coating. Longer term deployments may employ a UV-emitting device to prevent bio-fouling of the target and/or associated assembly. Exemplary materials useful in the fabrication of targets and/or referents 2 include, among others, aluminum alloys, electrolytic-grade copper, titanium, tungsten carbide with cobalt or nickel binder (e.g., 6%), ceramic (e.g., alumina), zinc, steel, stainless steel, high-silicon bronze, rubber, or other suitable material known in the art or capable of impingement and reliable echo production. In some embodiments, the target is hollow and may be vacuum-filled with a fluorocarbon liquid (e.g., FS-5, Fluorolube). Similar considerations also apply to the associated referent-locator 6, as well as referent/referent-locator assemblies.

Suitable materials and design of targets also take into account the depth at which the target (e.g., referent) will be deployed. As previously discussed, one feature of the invention is to provide calibration of sonar in the environment where the sonar may be in use (e.g., during operations, underway, moored). Therefore, the target must be capable of withstanding and reliably operating at a range of depths such as up to 100 m, up to 500 m, up to 1,000 m, up to 6,000 m, or up to 11,000 m, or full-ocean depth. In some embodiments, the target may be positively buoyant or neutrally buoyant. In another embodiment, the target in negatively buoyant.

Referent acoustic sources. Referent acoustic sources of the invention are used in conjunction with an acoustic source (referent)-locator means. General guidelines and methods for use of referent acoustic sources for the calibration of a sonar receiver or the receiving function of a transducer are known in the art. In most embodiments, standard acoustic sources (calibrated by direct measurement with a calibrated hydrophone) are employed.

Preferred referent acoustic sources transmit sound directionally in order to minimize or avoid generating echoes from extraneous scatterers such as the sea surface or seafloor. In the case of referent acoustic sources with omnidirectional transmission properties (e.g., at low frequencies), interfering echoes from extraneous scatterers are minimized through the careful geometrical arrangement of the referent acoustic source and sonar to be calibrated, utilizing part or all of the direct-path portion of the sonar signal.

The transmit power of the selected acoustic source should be adequate to overcome transmission losses to the receiver due to geometrical spreading of the beam and acoustic absorption, while at the same time avoiding the known detrimental effects of cavitation (e.g., by reducing source level).

In embodiments employing an acoustic source (or acoustic receiver), such devices may be powered by a battery or by a connection to a solar panel or array in cases involving an above-surface float or buoy.

In some embodiments, an echo repeater is used as a referent 2. In preferred uses, the echo repeater is calibrated. An echo repeater is often useful when the sonar 1 is separated from the referent 2 by relatively large distances, such that the transmitted signal might be relatively weak, and the echo generated from a passive standard target or other passive target might be undetectable at the sonar receiver. Calibration of an echo repeater most often consists of calibration of the constituent hydrophone, control of the signal amplification, and calibration of the constituent transmitter.

Referent acoustic receiver. An acoustic receiver with appropriate sensitivity, directionality, and frequency discrimination may be employed as a referent 2 for the reception of sound or to calibrate a sonar 1 exclusively in the transmit mode when specific transmission properties of the sonar 1 in the absence of an echo or backscattered acoustic signal need to be determined. In preferred embodiments, a previously calibrated hydrophone in association with a referent-locator 6 is positioned within the transmit beam of the sonar 1 being calibrated with a range and orientation sufficient to receive transmitted sound. In one embodiment, the acoustic receiver is an echo repeater of the art capable of recording the impinging sonar signal.

In all instances, it is preferred that the hydrophone position and orientation be optimized relative to extraneous scattering objects to avoid or minimize interfering echoes using considerations similar to those for calibrations using a standard target.

The referent-locator and its use. In one aspect of the invention, the referent-locator 6 or “locator” is physically associated (e.g., mechanically engaged, tethered, electronically connected, directly attached) with the calibration referent 2, at least during the calibration procedures. The purpose of the referent-locator 6 is to provide positional information to the locator-detector 7 regarding the precise location of the referent 2. Any system that can be physically associated with the referent 2 and which provides the desired precision regarding referent location may be employed as a referent-locator 6. In all cases, however, the referent-locator 6 is distinct from the sonar being calibrated and must not detrimentally interfere with the sonar 1 signally necessary for its calibration.

It is a necessary aspect of the invention that the referent-locator 6 communicate positional information (e.g., transmit, relay, reflect a signal) to the locator-detector 7 which in many instances will be present at a significant distance from the referent 2. The referent-locator 6 will either be surface-mounted in air or submerged with the referent in the same or different location. In either case, the signal carrying positional information from the locator 6 must be of usable quality when it reaches the locator-detector 7. Table 1 provides guidance for the selection of modalities based on surface or sub-surface use. Suitable modes of communication include, but are not limited to, optical communication (e.g., visible light, such as described in U.S. Pat. No. 7,953,326), acoustic communication (e.g., sound), radio communication (e.g., radar), global positioning system (GPS) data communication (e.g., satellite), or by any suitable method of communication including electromagnetic signals, microwave signals, pressure waves, reflected signals, and scattered signals.

TABLE 1
Referent-locator signal modality selection guidelines

| Modality | Medium | Range of applicability |
|---|---|---|
| Visible light | Underwater | 1 m to 200 m, wavelength- and |
| | | water clarity-dependent |
| Visible light | Air | <10 km, dependent on |
| | | atmospheric conditions |
| Sound | Underwater | <100 m to 10 km |
| Radar | Air | Horizon, of order 10 km |
| GPS + radio | Air | Horizon |

The referent-locator system 6 may comprise one or more of a surface unit, a sub-surface mid-water column unit, a bottom-mounted unit, or a combination of these. A unit may consist of one or more components sufficient for specifying (i) the position of the referent-locator 6, presuming that the relative position of the referent 2 is known, or (ii) the referent position directly. In one embodiment, the referent-locator 6 comprises a surface unit such as a buoy or other floating platform (e.g., weather buoy, off-shore platform) to receive positional information regarding the position of the referent 2. In another embodiment, the referent-locator 6 a sub-surface unit (e.g., sub-surface buoy, seafloor observatory) capable of receiving positional information on the location of the referent 2. In another embodiment, the referent-locator 6 is located on a vehicle (e.g., an AUV, a ROV, a glider, a submarine) which utilizes the vehicle's positioning to provide positional information with respect to the referent 2 wherein the referent may be located on the vehicle or at a known location.

For typical sonar system calibration procedures, the referent-locator 6 provides information suitable for localizing the referent 2 within the sonar beam. Acceptable tolerances for localization of the referent 2 are dictated by the need to sample the beamwidth, or angular width of the main lobe at the half-power points, with sufficient resolution. Preferred embodiments (at any range) take samples more than once, preferably more than 5 times and most preferably 10 or more times across the width of the beam. The samples need not be uniformly spaced, but it is advantageous if the spacing is more or less uniform.

One preferred example of a referent-locator 6 is a tri-corner reflector to reflect optical or radar signals. The reflector may be attached to a buoy to which a referent 2 is attached (e.g., suspended from, mounted on, or attached to the buoy). In another embodiment, using bottom-anchored deployments of buoyant standard targets, an acoustic transponder is attached to the bottom mounting. When interrogated by an acoustic localization system, such as a short- or ultra-short baseline system mounted on the sonar platform, the locator 6 responds with a ping, revealing the position of the transponder to within an offset. In some instances when using an acoustic referent-localizing means (referent-locator 6), a frequency distinct from that being used in the sonar calibration procedure will be employed to eliminate or minimize interference of the localizing signal with the sonar process.

Referent/referent-locator assembly. In many embodiments, the referent 2 and referent-locator 6 are physically connected (or in the vicinity suitable for communication to the extent required for the referent-locator 6 to be able to provide referent positioning data/information of the required precision to the referent-locator detector means 7. With respect to the localization of targets and standard targets for sonar system calibration, neither the referent-locator 6 nor the attachment means should produce echoes or backscattering which prohibit the analysis of target-generated backscattering necessary for a successful calibration. In some embodiments, the target-locator 6 will be configured so that it is outside of the sonar beam during the calibration run. Alternatively, the target-locator 6 may be situated within the sonar beam during the calibration run, if when within the sonar beam the target-locator 6 has a target strength considerably less than that of the calibration target (or standard target). In preferred embodiments, the target-locator 6 has a target strength during calibration of at least 20 decibels (dB) less than that of the target. In other embodiments target-locator 6 has a target strength less than at least 15 dB, 10 dB, 5 dB, or 2 dB relative to that of the referent/target 2. Strategies to reduce the target strength of the target-locator 6 include the use of designs using weakly reflective materials, shapes, and sizes as known to the art.

In some instances after deployment (e.g., referent-locator 6 suspended from a moored or drifting buoy) the referent-locator's position may vary with respect to the referent 2 depending on local currents, wind conditions, or drifting speeds. In these cases, a means to determine positional offset of the referent-locator 6 to the referent 2 (referent-offset) will be required. Any suitable mechanism for measuring and communicating referent-offset may be employed in the inventive methods as shown in Table 2. These include the use of a secondary, downward-looking (e.g., surface-mounted, side-mounted) sonar mounted in or on the referent-locator 6, or a secondary upward-looking (e.g., bottom-mounted, side-mounted) sonar. Alternatively, laser other electromagnetic-based or video tracking approaches may also be employed. Referent-offset data are relayed by an appropriate communication channel back to the referent-locator-detector 7 or directly to the analyzer 10.

In one embodiment, referent positioning and/or offset determination utilizes a split-beam scientific echo sounder. In another embodiment, relative positioning is determined using a second phase-measuring sonar that enables positioning of the referent 2 from the echo generated by the referent when ensonified by the referent-locator sonar component.

Deployment of the referent/referent-locator assembly. The referent/referent-locator assembly may be dropped overboard from a vessel at sea or aircraft (e.g., manned, unmanned). The referent/referent-locator may be activated before or after deployment, and the assembly may be tracked until proper alignment and range relative to the sonar 1 to be calibrated are reached. A further consideration in circumstances employing a direct physical link between the referent 2 and referent-locator 6 is that the attachment means of the locator 7 to the referent 2 must not detrimentally affect the calibration. A preferred attachment means known to not have detrimental effects on sonar calibrations utilizes plastic (e.g., nylon) mooring lines. In one preferred embodiment of the invention, the referent-locator 6 and referent 2 are supplied as a single device. In another embodiment, the referent-locator 6 and referent 2 are separate entities attached by a mechanical linkage (e.g., a tether, preferably a monofilament nylon line). Other linkages are possible if made from low echo-producing materials such as some plastics, rubbers, and other soft materials, and may be in the form of chain, rod, line, adhesive, and the like.

Expendable referent/referent-locator assemblies. In one embodiment, the assembly comprising the referent 2 and the referent-locator 6 is provided in expendable (disposable) format. Such assemblies are deployed over-the-side, launched from the platform of the sonar being calibrated, or from another platform such as a boat, ship, ROV, AUV, hROV, HOV, submarine, or aircraft, among others. In some embodiments, one or more referent/referent-locator assemblies are permanently affixed submerged in the water body for long-term deployment in applications such as navigation and surveys.

In some embodiments, the referent/referent-locator assembly is permanently mounted either suspended from a mooring or buoy or attached the seafloor to provide an area in which to calibrate the sonar system before, during, or after mission. In such cases, the sonar platform (e.g., a vehicle), may pass on, near, or around the referent/referent-locator assembly to calibrate the employed sonar system for use. In one embodiment, multiple referent/referent-locator assemblies are deployed to allow the sonar-comprising vehicle to make a single pass or make multiple passes by the assemblies (provided in any suitable arrangement) in order to take measurements for calibration (e.g., more than once, preferably more than 5 times and most preferably 10 or more times) across the width of the beam when in motion. In another embodiment, a single referent/referent-locator assembly is deployed wherein the sonar platform or vehicle may make one or more passes when driving by the referent/referent-locator assembly to take measurements for calibration.

In some aspects of the invention, it may be desirable for the referent 2 to be separate from the referent-locator 6 and without a physical link thereto. In certain instances, the referent 2 may be separated from the referent-locator 6 by 5 m, 10 m, 20 m, or 50 m or more. In other instances, the referent 2 may be separated from the locator 6 by more than 100 m to 1 km or greater. To obtain referent positioning information over such distances, any useful modality (e.g., acoustic, optic, radio, microwave, satellite, etc.) may be employed, provided the information generated is adequate for the intended calibration. In one embodiment, the modality for localizing the referent 2 is acoustic. More specifically, the referent-locator 6 is a calibrated sonar system distinct from the sonar 1 to be calibrated (the primary sonar). The referent-locator sonar, or secondary sonar, may be mounted on, or external to, the platform of the primary sonar 1 to be calibrated. In one embodiment, the secondary sonar is a long baseline sonar array on the seafloor.

Under any circumstance, during the calibration procedure the secondary sonar must be used in a way that it does not interfere with the signal or interpretation of the signal from the primary sonar 1. In one strategy to avoid interference, the secondary sonar is operated at a different frequency that is incompatible with the primary sonar frequency. In another embodiment, signal transmission from the secondary sonar is controlled to occur intermittently or synchronously out-of-phase with the primary sonar signal transmission.

The referent-locator-detector and its use. The referent-locator-detector 7 (locator-detector, or detector) provides positional information received from the referent-locator 6 to the calibration algorithm (e.g., by way of an analyzer 10) in order to augment the information derived from the referent 2, either relayed to or directly from the sonar system 1. Suitable locator-detectors 7 are chosen based on the signal modality relayed or generated by the referent-locator 6 as described in Table 2 below and as is known to practitioners of the art. Referent-locators 6 must be paired with an appropriate detection device in order to effectively relay referent position for adequate calibration.

TABLE 2
Referent-locators and corresponding locator-detectors

| | | |
|---|---|---|
| Referent- | Referent-locator | |
| locator | detector | Configuration and utility |

A. Known static offset configurations

| | | |
|---|---|---|
| Surface buoy | Optical sighting or radar | Visual siting or radar |
| | measurement | measurement. |
| Tri-corner | Optical sighting or radar | Visual siting or radar |
| reflector or | measurement | measurement. |
| retro-reflector | | |
| Other radar | Radar | Radar measurement. |
| reflector | | |
| Acoustic | Acoustic receiver | Acoustic reception |
| modem | | measurement. Modem |
| | | may be submerged or on |
| | | the surface. |
| Optical | Optical receiver | Optical reception |
| modem | | measurement. Modem |
| | | may be submerged or on |
| | | the surface. |
| Pinger | Long, short, or ultra-short | Bottom-mounting for long |
| | baseline systems (LBL, | baseline (LBL), vessel- |
| | SBL, USBL) | mounting for short |
| | | baseline (SBL), or ultra- |
| | | short baseline (USBL) |
| | | systems. |
| Transponder | Long, short, or ultra-short | Bottom-mounting for LBL, |
| | baseline system (LBL, | vessel-mounting for SBL, |
| | SBL, USBL) | or USBL systems. |

B. Dynamic offset configurations

| | | |
|---|---|---|
| Split-beam | Acoustic or optical | This configuration is |
| scientific | modem or GPS with radio | suitable for surface or |
| echo sounder | or telephone signal, | bottom mounting. |
| | location-dependent. | |
| Other | Acoustic or optical | This configuration is |
| phase- | modem or GPS with radio | suitable for surface or |
| measuring | or telephone signal, | bottom mounting. |
| sonar | location-dependent. | |

The analyzer means. The analyzer 10 can be any electronic/digital means for incorporating the positional information derived from the detector into the calibration algorithm. Most often, the analyzer 10 will be a computer or data processor, or equivalent. The analyzer means 10 may be a stand-alone electronic device or analyzer functionality may be incorporated into the electronics package of the sonar system 1, locator-detector 7, or any other suitable device or system. In some embodiments, the analyzer 10 also receives input from the sonar system 1.

Calibrating the sonar system. It is an advantage of the invention that by associating a referent-locator 6 with the referent 2, during calibration, the position of the referent 2 may be precisely determined even when either or both the sonar platform and the referent 2 are in motion.

Procedures and equations for calibrating sonar systems, such as those employing standard targets, are known and may be followed when performing sonar or sonar component calibrations employing the inventive components and methods. In general, following appropriate selection and positioning of the referent 2 and collecting backscattering or other acoustic data, the precise location of the referent 2 as determined with the locator-detector 7 is included in, and processed by the calibration algorithm as is known to the art.

Generally speaking, the inventive calibration method requires the deployment of a referent/referent-locator assembly to a position remote from the sonar platform. Either before or after deployment, the sonar system 1 and referent-locator systems 6 are activated to commence signal transmission, with a common reference time, or with access to a common reference time signal. The sonar calibration is initiated wherein a one or more acoustic calibration signals are transmitted. During part or all of the transmission of the calibration signal, or alternatively, closely bracketing the signal transmission, positional information localizing the referent 2 is provided from the referent-locator 6 to the locator-detector 7. The measured sonar transfer function or characteristic as determined by each individual acoustic measurement is then combined with the calibration data to determine the correct transfer function or characteristic of the transducer and/or an aspect of sonar performance. Aspects of sonar performance may comprise transmit response, combined transmit-receive response, receiver sensitivity, onset of cavitation, source level, dynamic range, maximum detection range, receiver saturation limit, lower limit of receive sensitivity, nearfield-farfield transition, linearity in response, directionality (e.g., beam pattern), and self-noise of the system.

The transfer functions and/or characteristics are mathematically transformed to a form convenient for operational use through (a) application in sonar data post-processing, and/or (b) adjustment of operator-accessible sonar parameters, as is known to the art.

As described herein, the acoustic calibration signal depending upon the nature of the instrumentation being calibrated, may be an acoustic signal initiated by a sonar transducer, or by a referent acoustic source or both.

Standard procedures for calibrating electroacoustic transducers used in transmission or in reception are presented in the following standard: ANSI/ASA S1.20-2012, “American National Standard: Procedures for calibration of underwater electroacoustic transducers” (Acoustical Society of America, Melville, N.Y., 2012). This is available at http://webstore.ansi.org/RecordDetail.aspx?sku=ANSI%2fASA+S1.20-2012 (last viewed 4 Sep. 2014). Principles for calibrating active sonars used for echo measurement are presented in Annex F of the same reference. This is the standard-target method developed initially for calibrating scientific echo sounders at sea (Foote 1982) and wideband echo measurements in a laboratory tank (Dragonette et al. 1981). Exemplary guidelines for calibrating scientific echo sounders by the standard-target method are provided by Foote (1987), (ICES Coop. Res. Rep., 144, 69 pp).

### EXAMPLE 1

### Calibration of a Towed Sidescan Sonar

This example describes the in-motion calibration of a towed, sidescan sonar using an anchored buoyant referent.

An EdgeTech model 260-TH Image Correcting Side Scan sonar, with model 272-TD dual-frequency analog towed vehicle, with operating frequencies at 100 kHz and 400 kHz, is towed from a 10-m long boat. The transducer axes are adjusted at a declination of 10 degrees, hence pointing 10 degrees below the horizontal.

A 152.4-mm diameter, thin-walled focusing sphere filled with a fluorocarbon liquid, as described by Deveau and Lyons (1995) (IEEE Journal of Oceanic Engineering 34, 93-100), is used as a standard target.

The standard target is attached to a monofilament line connected to a bottom weight and a float at the free end. The target height over bottom is chosen to be 1.5 m.

A subsurface float consisting of a hollow-glass pressure vessel equipped with radio transmitter electronics and an antenna (i.e., referent-locator) that extends above the sea surface is also attached to the bottom weight.

During repeated transects, the position of the target assembly is broadcast by radio signal that is detected with a directional radio unit on board the boat that is towing the sidescan sonar.

Registration of echoes from the standard target can be related to the target position, enabling the overall transmit-receive response of the sidescan sonar to be determined at each frequency.

### EXAMPLE 2

### Calibration of an AUV-Mounted Sidescan Sonar

This example describes the underway calibration of a sidescan sonar mounted on an AUV using an anchored buoyant referent.

The Remote Environmental Measuring UnitS (REMUS) 100 autonomous underwater vehicle (AUV) is configured with a Marine Sonic Technology dual-frequency sidescan sonar operating at 300 kHz and 1800 kHz.

A 91.44-mm diameter hollow ceramic flotation sphere is used as a standard target. (Atkins et al., (2007) Oceans, Europe IEEE Conference Proceedings, 4 pp [doi:10.1109/OCEANSE.2007.4302487]).

This standard target is attached to a bottom weight by a 2-m length of monofilament nylon.

An acoustic transponder (i.e., referent-locator) is also attached to the bottom weight.

During operations within acoustic range of the target, the position of the target is determined with an ultrashort-baseline system (USBS) mounted on the mother ship.

Registration of echoes from the standard target can be related to the target position in the sonar beams based on knowledge of the target position and AUV.

The combined transmit-receive response can then be determined.

### EXAMPLE 3

### Calibration of a Scientific Multibeam Sonar Mounted on a Research Vessel

This example describes the calibration of a scientific multibeam sonar mounted on the hull of a research vessel that is drifting or in motion.

The Simrad model MS70 Scientific multibeam sonar, with broadband frequency range 70 kHz to 120 kHz, is mounted on the hull of a research vessel.

Two standard targets are chosen to cover the total operating frequency band in piecewise fashion. These are solid spheres fabricated from tungsten carbide with 6% cobalt binder, with diameter 75-mm and 84-mm as described by Foote (in Oceans 2006 MTS/IEEE Boston Conference Proceedings, 4 pp. [doi: 10.1109/OCEANS.2006.306944]; and, in Oceans 2007 Europe IEEE Aberdeen Conference Proceedings, 4 pp. [doi: 10.1109/OCEANSE.2007.4302355]).

The targets are attached to a line consisting of 2-mm diameter monofilament nylon. Also attached to the line are a bottom weight and a float at the free end of the line to hold the targets off the bottom. The several components, namely bottom weight, spheres, and buoyance float, are spaced at 10-m intervals.

An acoustic pinger (i.e., referent-locator) is attached to the float. This pings at frequent, regular intervals, enabling an on-board, short-baseline system to monitor is position relative to the vessel and hull-mounted multibeam sonar.

Since the target position is known, those beams that register the standard targets can be calibrated directly.

### EXAMPLE 4

### Calibration of the Difference-Frequency Beam of an On-Board Parametric Sonar

This example describes the calibration of the difference-frequency beam of a parametric sonar mounted on a fixed or tiltable platform also with electronic beam steering, attached to the hull of an ocean-going vessel.

The Kongsberg model TOPAS PS18 Parametric sub-bottom profiler, with primary-frequency band 15 kHz to 21 kHz and difference frequencies in the band 0.5 kHz to 6 kHz, is mounted on a tiltable hull-mounted platform on a large research vessel. The associated transducer array is approximately 1 m² in area. The transducer platform is deployed with axis pointing 7.5 degrees downward from the horizontal plane.

The standard target is a solid sphere, diameter 280-mm, machined from a rod of the aluminum alloy 6082 T6 as described by Foote et al. (2007), (J. Acoust. Soc. Am. 121, 1482-1490).

The target is suspended at a depth of 300 m from a surface float that is otherwise free to drift.

The surface float is equipped with a radar reflector that enables its position to be precisely determined from the research vessel.

The surface float is also equipped with a Simrad EK60 split-beam scientific echo sounder with an operating frequency of 18 kHz that enables the standard target position to be precisely monitored.

When the target is registered in the parametric sonar beam, its position is known from the echo sounder, enabling the combined transmit-receive response to be determined at a single difference frequency or over the difference-frequency band corresponding to the parametric sonar transmit signal.

What is claimed:

1) A sonar calibration assembly, comprising:
a sonar system with at least one sonar transducer;
a remote referent detectable by said sonar system;
a referent-locator having a known position with respect to said referent;
a locator-detector; and
an analyzer;
wherein the referent-locator is capable of providing referent positional information to the locator-detector, and the locator-detector is capable of providing a signal to the analyzer regarding said referent position, enabling the analyzer to generate a signal useful for calibrating the sonar system.

2) The assembly of claim 1, wherein the referent-locator is activated to send positional information to the locator-detector in response to a received ping from said sonar system.

3) The assembly of claim 1, wherein the referent-locator communicates positional information to said locator-detector by means of a signal selected from the group comprising an electromagnetic signal, a radar signal, a microwave signal, an optical signal, an acoustic signal, a pressure wave, a reflected signal, and a scattered signal.

4) The assembly of claim 1, wherein the referent is a target or a standard target.

5) The assembly of claim 1, wherein said referent-locator physically linked to the referent.

6) The assembly of claim 1, wherein said referent-locator is physically separated from the referent.

7) The assembly of claim 1, wherein said referent-locator is located on a buoy, a float, a vehicle, an AUV, or a landmark.

8) The assembly of claim 1, wherein the referent-locator acquires the information for localizing the referent by global positioning satellite (GPS) communication, radio communication, by mapping, the associated vehicle navigation system, or by a known location.

9) The assembly of claim 1, wherein the sonar system is selected from the group comprising an echo sounder, a scientific echo sounder, a single-beam sonar, a dual-beam sonar, a split-beam sonar, a multibeam sonar, a scanning sonar, a sidescan sonar, a phase-measuring sidescan sonar, a monostatic-array sonar, a bistatic-array sonar, a multistatic-array sonar, a two-dimensional billboard-type array sonar, a three-dimensional sonar, a parametric sonar, a sub-bottom profiling sonar, and modifications and derivatives thereof.

10) The assembly of claim 1, wherein the locator-detector is integral to the sonar system.

11) The assembly of claim 1, wherein the locator-detector is modular and connected to the sonar system.

12) The assembly of claim 1, wherein the sonar calibration assembly performs sonar calibration in situ.

13) The assembly of claim 12, wherein the sonar calibration assembly performs sonar calibration while stationary, in motion, or during operations.

14) The assembly of claim 1, wherein the sonar calibration assembly determines at least one aspect of sonar performance selected from the group comprising transmit response, combined transmit-receive response, receiver sensitivity, onset of cavitation, source level, dynamic range, maximum detection range, receiver saturation limit, lower limit of receive sensitivity, nearfield-farfield transition, linearity in response, directionality (e.g., beam pattern), and self-noise of the system.

15) A platform-independent sonar calibration package for use in calibrating a sonar system comprising:
a standard target in communication with a target-locator; and
a locator-detector;
wherein the target-locator is capable of providing target positional information to the locator-detector, and the detector is capable of providing an output signal regarding target position in a form suitable for use in a sonar calibration algorithm.

16) The calibration package of claim 15, wherein the sonar calibration is performed in situ.

17) The calibration package of claim 15, wherein the target and target-locator are physically linked.

18) A method for determining the state of calibration of a sonar system comprising the steps of:
(i) Providing and deploying a referent and a referent-locator system;
(ii) Initiating the sonar system and referent-locator system to commence signal transmission, with a common reference time;
(iii) Executing a series of measurements based on signal exchange between the referent and sonar system;
(iv) Providing a referent location relative to the sonar system from the locator-detector for a primary acoustic measurement with the referent; and
(v) Determining the sonar transfer function or characteristic from a primary acoustic measurement to determine an aspect of sonar performance.

19) The method of claim 18, the referent-locator acquires the information for localizing the referent by global positioning satellite (GPS) communication, radio communication, by mapping, the associated vehicle navigation system, or by knowing the location.

20) The method of claim 18, wherein the referent-locator provides the referent location to the sonar system by means of the locator-detector by a signal selected from the group comprising an electromagnetic signal, a radar signal, a microwave signal, an optical signal, an acoustic signal, a pressure wave, a reflected signal, and a scattered signal.

21) The method of claim 18, wherein at least one aspect of sonar performance is determined for determining the state of calibration selected from the group comprising transmit response, combined transmit-receive response, receiver sensitivity, onset of cavitation, source level, dynamic range, maximum detection range, receiver saturation limit, lower limit of receive sensitivity, nearfield-farfield transition, linearity in response, directionality (e.g., beam pattern), and self-noise of the system.

22) The method of claim 18, further comprising the step of employing the determined sonar transfer function or characteristic for calibration of the sonar system.
